(19) United States
(12) Patent Application Publication
(10) Pub. No.: US 2008/0154416 A1
(43) Pub. Date: Jun. 26, 2008

(54) Apparatus and method to monitor an out-sourced manufacturing process

(75) Inventors: Allen Keith Bates, Tucson, AZ (US); Shinobu Wada, Tokyo (JP); Daniel James Winarski, Tucson, AZ (US)

Correspondence Address: DALE F. REGELMAN;QUARLES & BRADY, LLP, ONE SOUTH CHURCH AVENUE, STE. 1700, TUCSON, AZ, 85701-1621, US

(73) Assignee: International Business Machines Corporation, Armonk, NY (US)

(21) Appl. No.: 11/643,346

(22) Filed: Dec. 20, 2006

(51) Int. Cl. G06F 19/00

(52) U.S. Cl. 700/108

(57) ABSTRACT

A method is disclosed to monitor an out-sourced manufacturing process: A second manufacturer, manufactures a product under contract with a first manufacturer, using an out-sourced manufacturing process. The method supplies a yield monitoring assembly in communication with both the first manufacturer and the second manufacturer. The method establishes a warning threshold, calculates a measured out-sourced manufacturing process yield, and determines if the measured out-sourced manufacturing process yield is greater than said warning threshold. If the method determines that the measured out-sourced manufacturing process yield is not greater than the warning threshold, then the method provides a warning message to the first manufacturer.

### FIELD OF THE INVENTION

This invention relates to an apparatus and method to monitor the product yield realized by an out-sourced manufacturing process.

### BACKGROUND OF THE INVENTION

Manufacturers sometimes out-source certain production elements, wherein a product is manufactured by a second manufacturer under contract with a first manufacturer using an out-sourced manufacturing process. The first manufacturer has no means to monitor in real time the product yield realized by the second manufacturer.

### SUMMARY OF THE INVENTION

What is needed is an apparatus and method to measure in real time the product yield realized by the second manufacturer, to compare that measured product yield with a pre-determined warning threshold, and if the measured product yield is not greater than the warning threshold, provide a warning message to the first manufacturer.

Applicants' invention comprises a method to monitor an out-sourced manufacturing process. Using Applicants' method, a second person, such as for example a second manufacturer, manufactures a product under contract with a first person, such as for example a first manufacturer, using an out-sourced manufacturing process, wherein that process starts with (N) starting product assemblies and produces (M) completed products.

The method supplies a yield monitoring assembly in communication with the second person and in communication with the first person. The method establishes a warning threshold, calculates a measured out-sourced manufacturing process yield equal to (M)/(N), and determines if the measured out-sourced manufacturing process yield is greater than the warning threshold. If the method determines that the measured out-sourced manufacturing process yield is not greater than the warning threshold, then the method provides a warning message to the first person.

### BRIEF DESCRIPTION OF THE DRAWINGS

The invention will be better understood from a reading of the following detailed description taken in conjunction with the drawings in which like reference designators are used to designate like elements, and in which:

FIG. 1 is a block diagram showing the information pathways and product delivery pathways used by Applicants' method to monitor an out-sourced manufacturing process; and

FIG. 2 is a flow chart summarizing Applicants' method.

### DETAILED DESCRIPTION OF THE PREFERRED EMBODIMENTS

This invention is described in preferred embodiments in the following description with reference to the Figures, in which like numbers represent the same or similar elements. Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are recited to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Applicants' invention comprises a method to monitor the quality of out-sourced goods and/or services. By “out-sourced goods and/or services,” Applicants mean products manufactured by a second person under contract to a first person, wherein the second person uses an out-sourced manufacturing process. In certain embodiments, the out-sourced manufacturing process is designed by, and owned by, the first person. In certain embodiments, the out-sourced manufacturing process is designed by, and owned by, the second person.

Reference herein to a “first person” refer to a first legal entity, wherein that first legal entity may comprise one or more natural persons and/or an unnatural person such as and without limitation a partnership, a corporation, a limited liability company, and the like. Reference herein to a “second person” refer to a second legal entity, wherein that second legal entity may comprise one or more natural persons and/or an unnatural person such as and without limitation a partnership, a corporation, a limited liability company, and the like.

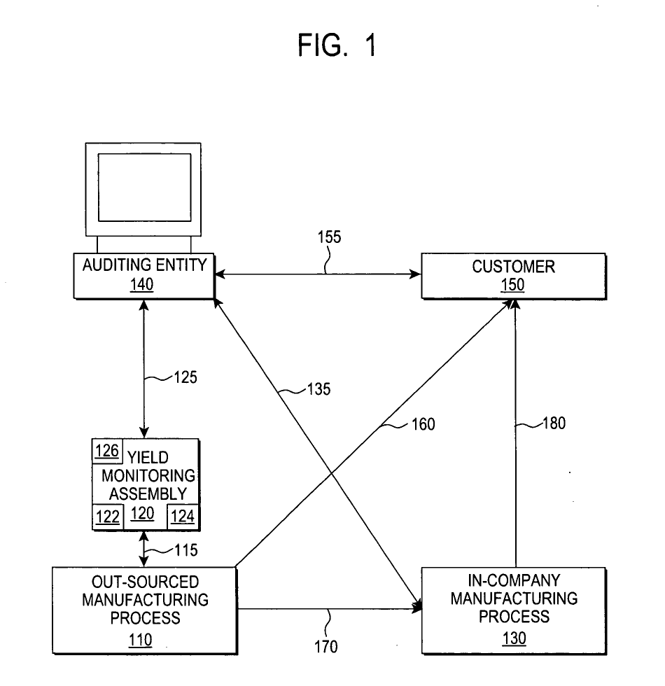

Referring now to FIG. 1, out-sourced manufacturing process 110 produces goods for first person 140, referred to herein as the auditing entity 140. In certain “private labeling” embodiments, out-sourced manufacturing process 110 provides those goods directly to a customer 150 in accord with product movement pathway 160. In other embodiments, out-sourced manufacturing process 160 provides goods to an in-company manufacturing process 130 along product movement pathway 170. Thereafter, in-company manufacturing process 130 provides goods to customer 150 along product movement path 180.

In order to monitor the quality of the goods produced by out-sourced manufacturing process 110, auditing entity 140 receives information from out-sourced manufacturing process 110. In certain embodiments, auditing entity 140 (FIG. 1) installs a yield monitoring assembly 120 which receives production data from out-sourced manufacturing process 110 using information pathway 115. In the illustrated embodiment of FIG. 1, yield monitoring assembly 120 comprises memory 124 and a processor 126. In certain embodiments, yield monitoring assembly 120 optionally further comprises a Management Information Base 122 which defines a Simple Network Management Protocol (“SNMP”).

The yield monitoring assembly 120 generates a measured out-sourced manufacturing process yield, and provides that measured out-sourced manufacturing process yield to the auditing entity 140 using information pathway 125. In certain embodiments, the auditing entity 140 is collocated with the yield monitoring assembly 120. In other embodiments, the yield monitoring assembly 120 is collocated with the out-sourced manufacturing process 110. In yet other embodiments, the yield monitoring assembly 120 is not collocated with either the auditing entity 140 or with the out-sourced manufacturing process 110.

Information pathways 115 and 125 may comprise any data input / output (“I/O”) hardware, software, firmware, and/or protocol, such as and without limitation Small Computer Systems Interface (“SCSI”) protocol running over a Fibre Channel (“FC”) physical layer, Infiniband, Ethernet, Internet SCSI (“iSCSI”), and the like.

The auditing entity 140 is in communication with customer 150 via information pathway 155. In certain embodiments, the auditing entity 140 is also in communication with in-company manufacturing process 130 via information pathway 135. Information pathways 135 and 155 may comprise any data input/output (“I/O”) hardware, software, firmware, and/or protocol, such as and without limitation Small Computer Systems Interface (“SCSI”) protocol running over a Fibre Channel (“FC”) physical layer, Infiniband, Ethernet, Internet SCSI (“iSCSI”), and the like.

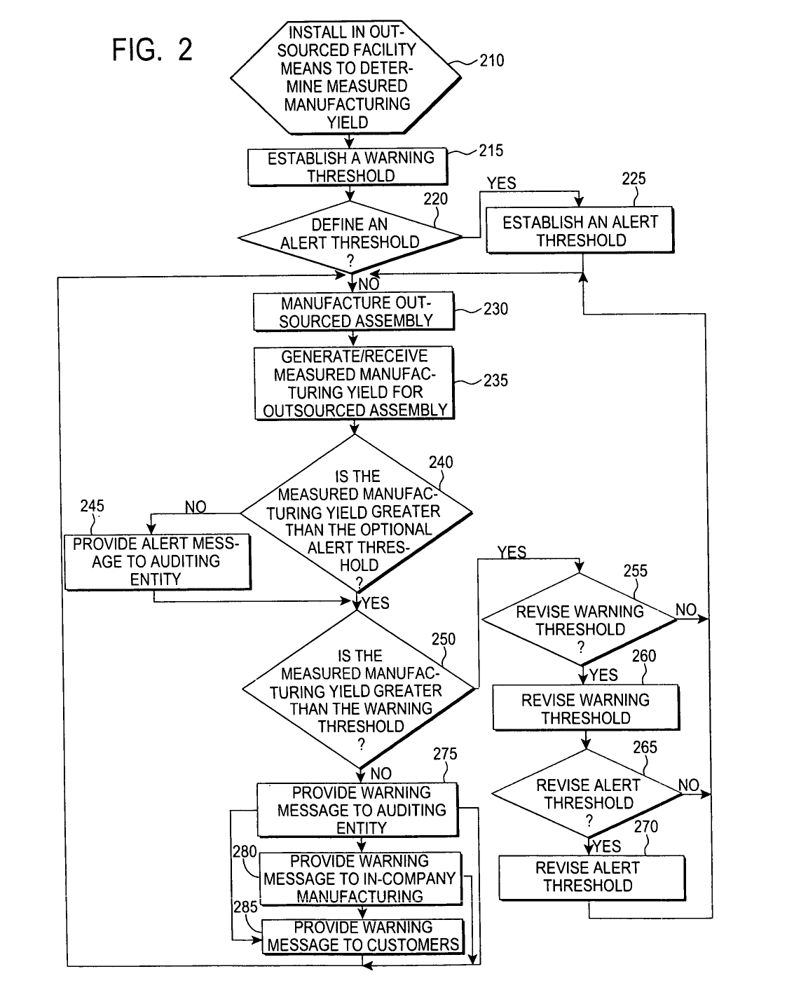

FIG. 2 summarizes the steps of Applicants' method. Referring now to FIG. 2, in step 210 Applicants' method installs in a manufacturing process a means, such as yield monitoring assembly 120, to determine a measured out-sourced manufacturing process yield. In certain embodiments, Applicants' method provides to the auditing entity 140 (FIG. 1) a measured out-sourced manufacturing process yield using a simple network management protocol (“SNMP”), wherein that SNMP is defined in a Management Information Base (“MIB”) 122.

In step 215, Applicants' method establishes a warning threshold. In certain embodiments, step 215 further comprises providing the warning threshold to Applicants' yield monitoring assembly 120 (FIG. 1).

In certain embodiments, Applicants' warning threshold is defined as a minimally-acceptable production yield. Applicants' have found that as the measured out-sourced manufacturing process yield decreases, the number of barely-qualifying product assemblies increases.

Applicants have further found that such barely-qualifying assemblies, although passing all applicable QA/QC protocols, nevertheless tend to show a decreased mean time between failure (“MTBF”). Applicants have further found that such barely-qualifying assemblies are sometimes prone to exhibit marginal performance in actual use. As those skilled in the art will appreciate, a decreased MTBF and/or continuing marginal performance can generate customer dissatisfaction.

In step 220, Applicants' method determines whether to establish an alert threshold. Such an alert threshold in combination with the warning threshold define a suspect zone. As an example, if Applicants' method sets a warning threshold in step 215 at 0.95, and in step 225 sets a suspect zone at 0.955, then a measured out-sourced manufacturing process yield less than or equal to 0.955 but greater than 0.95 falls within such a suspect zone.

If Applicants' method elects in step 220 to establish an alert threshold, then the method transitions from step 220 to step 225 wherein the method sets such an alert threshold. In certain embodiments, step 225 further comprises providing the alert threshold to Applicants' yield monitoring assembly 120 (FIG. 1). Applicants' method transitions from step 225 to step 230.

In certain embodiments, the alert threshold of step 225 is established by the auditing entity 140 (FIG. 1). In certain of these embodiments, the alert threshold of step 225 is provided by the auditing entity 140 (FIG. 1) to the yield monitoring assembly 120 via information pathway 125.

In certain embodiments, the alert threshold of step 225 is established by the customer 150 (FIG. 1). In certain of these embodiments, the alert threshold of step 225 is provided by the customer 150 (FIG. 1) to the auditing entity 140 (FIG. 1) via information pathway 155, and the auditing entity forwards the alert threshold to the yield monitoring assembly 120 via information pathway 125.

In certain embodiments, the alert threshold of step 225 is established by the in-company manufacturing process 130. In certain of these embodiments, the alert threshold of step 225 is provided by the in-company manufacturing process 130 to the auditing entity 140 (FIG. 1) via information pathway 135, and the auditing entity 140 (FIG. 1) forwards the alert threshold to the yield monitoring assembly 120 via information pathway 125.

If Applicants' method elects in step 220 not to establish an alert threshold, then the method transitions from step 220 to step 230 wherein the method manufactures the out-sourced product assembly. In certain embodiments, the product of step 230 is provided to one or more customers 150 by the out-sourced manufacturing process 110. In other embodiments, the product of step 230 is provided to in-company manufacturing process 130.

Applicants' method transitions from step 230 to step 235 wherein the method calculates a measured out-sourced manufacturing process yield. In certain embodiments, step 235 is performed by yield monitoring assembly 120.

In certain embodiments, in step 235 the out-sourced manufacturing process 110 provides to yield monitoring assembly 120, for a designated time interval, the number (N) of starting product assemblies and the number (M) of completed, tested, and qualified assemblies. In these embodiments, yield measurement means 120 then divides the number of completed, tested, and qualified assemblies (M) by the number of starting product assemblies (N) to calculate a measured out-sourced manufacturing process yield for the designated time interval.

In certain embodiments, the designated time interval comprises one manufacturing day. In certain embodiments, the designated time interval comprises a 24-hour interval. In certain embodiments, the designated time interval is greater than a 24-hour interval. In certain embodiments, the designated time interval is less than a 24-hour interval.

Embodiments of Applicants' method that include step 225 also include steps 240 and 245. In these embodiments, Applicants' method transitions from step 235 to step 240.

Embodiments of Applicants' method that do not include step 225 do not include steps 240 and 245, and in these embodiments Applicants' method transitions from step 235 to step 250.

In step 240, Applicants' method determines if the measured out-sourced manufacturing process yield is greater than the optional alert threshold. Step 240 further comprises retrieving a pre-determined alert threshold. In certain embodiments, step 240 is performed by Applicants' yield monitoring assembly 120. In certain embodiments, step 240 is performed by the auditing entity 140 (FIG. 1).

If Applicants' method determines in step 240 that the measured out-sourced manufacturing process yield is not greater than the optional alert threshold, then Applicants' method transitions from step 240 to step 245 wherein the method generates an alert message, and provides that alert message to the auditing entity 140 (FIG. 1). Applicants' method transitions from step 245 to step 250.

If the auditing entity receives an alert message, the auditing entity may take early corrective action advising the out-sourced manufacturing process to review and upgrade its manufacturing process. In addition or in the alternative, the auditing entity may advise the customer 150 (FIG. 1) of potential QA/QC issues. In addition or in the alternative, the auditing entity may advise the in-company manufacturing process 130 of potential QA/QC issues.

If Applicants' method determines in step 240 that the measured manufacturing yield is greater than the optional alert threshold, then Applicants' method transitions from step 240 to step 250 wherein the method determines if the measured out-sourced manufacturing process yield of step 235 is greater than the warning threshold of step 215. Step 250 further comprises retrieving a pre-determined warning threshold. In certain embodiments, step 250 is performed by Applicants' yield monitoring assembly 120. In other embodiments, step 250 is performed by the auditing entity 140 (FIG. 1).

If Applicants' method determines in step 250 that the measured out-sourced manufacturing process yield of step 235 is not greater than the warning threshold of step 215, then Applicants' method transitions from step 250 to step 275 wherein the method provides a warning message to the auditing entity 140 (FIG. 1). In certain embodiments, step 275 is performed by Applicants' yield monitoring assembly 120.

If the auditing entity 140 (FIG. 1) receives a warning message, the auditing entity 140 (FIG. 1) may demand that the out-sourced manufacturing process review and upgrade its manufacturing process. In addition or in the alternative, the auditing entity 140 (FIG. 1) may advise the customer 150 (FIG. 1) of likely QA/QC issues. In addition or in the alternative, the auditing entity 140 (FIG. 1) may advise the in-company manufacturing process 130 of likely QA/QC issues.

The following example is presented to further illustrate to persons skilled in the art how to make and use the invention. This example is not intended as a limitation, however, upon the scope of the invention, which is defined by the claims recited herein.

### EXAMPLE

In this example, Applicants' yield monitoring assembly 120 calculates the measured out-sourced manufacturing process yield of step 235. If that measured out-sourced manufacturing process yield is greater than the alert threshold of step 225, then in step 240 Applicants' yield monitoring assembly, using the protocol defined in MIB 122, sets an SNMP address of 1. If Applicants' yield monitoring assembly 120 determines in step 250 that the measured out-sourced manufacturing process yield is not greater than the alert threshold of step 225 but is greater than the warning threshold of step 215, then in step 250 the yield monitoring assembly 120, using the protocol defined in MIB 122, sets an SNMP address of 2, and provides that SNMP address to the auditing entity 140 (FIG. 1). If Applicants' yield monitoring assembly 120 determines in step 250 that the measured out-sourced manufacturing process yield is not greater than the warning threshold of step 215, then in step 250 the yield monitoring assembly 120, using the protocol defined in MIB 122, sets an SNMP address of 3, and provides that SNMP address to the auditing entity 140 (FIG. 1).

In this example, the auditing entity can at any time request the current SNMP address from Applicants' yield monitoring assembly 120. If the auditing entity receives an SNMP address of 1, then the auditing entity knows that the out-sourced manufacturing process yield exceeds both the alert and warning thresholds. If the auditing entity receives an SNMP address of 2, then the auditing entity knows that the out-sourced manufacturing process yield exceeds the warning threshold but not the alert threshold. If the auditing entity receives an SNMP address of 3, then the auditing entity knows that the out-sourced manufacturing process yield is below both the alert and warning thresholds.

In certain embodiments, Applicants' method transitions from step 275 to step 230 and continues as described herein. In other embodiments, Applicants' method transitions from step 275 to step 280 wherein the method provides a warning message to the in-company manufacturing process 130. In certain embodiments, step 280 is performed by the auditing entity 140 (FIG. 1). In certain embodiments, Applicants' method transitions from step 280 to step 285. In other embodiments, Applicants' method transitions from step 280 to step 230 and continues as described herein.

In certain embodiments, Applicants' method transitions from step 275 to step 285 wherein the method provides a warning message to customer 150 (FIG. 1). In certain embodiments, step 285 is performed by the auditing entity 140 (FIG. 1). Applicants' method transitions from step 285 to step 230 and continues as described herein.

If Applicants' method determines in step 250 that the measured out-sourced manufacturing process yield of step 235 is greater than the warning threshold of step 215, then Applicants' method transitions from step 250 to step 255 wherein the method determines whether a revision of the warning threshold is required. In certain embodiments, step 255 is performed by the auditing entity 140 (FIG. 1).

If Applicants' method elects not to revise the warning threshold, then Applicants' method transitions from step 255 to step 230 and continues as described herein. Alternatively, if Applicants' method elects to revise the warning threshold, then Applicants' method transitions from step 255 to step 260 wherein the method revises the warning threshold. In certain embodiments, step 260 is performed by the auditing entity 140 (FIG. 1).

In certain embodiments, the revised warning threshold of step 260 is established by the auditing entity 140 (FIG. 1). In certain of these embodiments, the revised warning threshold of step 260 is provided by the auditing entity 140 (FIG. 1) to the yield monitoring assembly 120 via information pathway 125.

In certain embodiments, the revised warning threshold of step 260 is established by the customer 150 (FIG. 1). In certain of these embodiments, the revised warning threshold of step 260 is provided by the customer 150 (FIG. 1) to the auditing entity 140 (FIG. 1) via information pathway 155, and the auditing entity forwards the revised warning threshold to the yield monitoring assembly 120 via information pathway 125.

In certain embodiments, the revised warning threshold of step 260 is established by the in-company manufacturing process 130. In certain of these embodiments, the revised warning threshold of step 260 is provided by the in-company manufacturing process 130 to the auditing entity 140 (FIG. 1) via information pathway 135, and the auditing entity 140 (FIG. 1) forwards the revised warning threshold to the yield monitoring assembly 120 via information pathway 125.

Applicants' method transitions from step 260 to step 265 wherein the method determines whether a revision the alert threshold is required. In certain embodiments, step 265 is performed by the auditing entity 140 (FIG. 1). If Applicants' method elects not to revise the alert threshold, then Applicants' method transitions from step 265 to step 230 and continues as described herein.

Alternatively, if Applicants' method elects to revise the alert threshold, then Applicants' method transitions from step 265 to step 270 wherein the method revises the alert threshold. Applicants' method transitions from step 270 to step 230 and continues as described herein.

In certain embodiments, the revised alert threshold of step 270 is established by the auditing entity 140 (FIG. 1). In certain of these embodiments, the alert warning threshold of step 270 is provided by the auditing entity 140 (FIG. 1) to the yield monitoring assembly 120 via information pathway 125.

In certain embodiments, the revised alert threshold of step 270 is established by the customer 150 (FIG. 1). In certain of these embodiments, the revised alert threshold of step 270 is provided by the customer 150 (FIG. 1) to the auditing entity 140 (FIG. 1) via information pathway 155, and the auditing entity forwards the revised alert threshold to the yield monitoring assembly 120 via information pathway 125.

In certain embodiments, the revised alert threshold of step 270 is established by the in-company manufacturing process 130. In certain of these embodiments, the revised alert threshold of step 270 is provided by the in-company manufacturing process 130 to the auditing entity 140 (FIG. 1) via information pathway 135, and the auditing entity 140 (FIG. 1) forwards the revised alert threshold to the yield monitoring assembly 120 via information pathway 125.

In certain embodiments, individual steps recited in FIG. 2 may be combined, eliminated, or reordered.

In certain embodiments, Applicants' invention includes instructions residing memory 124 (FIG. 1), where those instructions are executed by a processor, such as processor 126 (FIG. 1), to perform one or more of steps 215, 225, 235, 240, 245, 250, 260, 270, 275, 280, and/or 285 recited in FIG. 2.

In other embodiments, Applicants' invention includes instructions residing in any other computer program product, where those instructions are executed by a computer external to, or internal to, system 100, to perform one or more of steps 215, 225, 235, 240, 245, 250, 260, 270, 275, 280, and/or 285 recited in FIG. 2. In either case, the instructions may be encoded in an information storage medium comprising, for example, a magnetic information storage medium, an optical information storage medium, an electronic information storage medium, and the like. By “electronic storage media,” Applicants mean, for example, a device such as a PROM, EPROM, EEPROM, Flash PROM, compactflash, smartmedia, and the like.

While the preferred embodiments of the present invention have been illustrated in detail, it should be apparent that modifications and adaptations to those embodiments may occur to one skilled in the art without departing from the scope of the present invention as set forth in the following claims.

We claim:

1. A method to monitor an out-sourced manufacturing process, comprising the steps of:
manufacturing a product by a second person under contract with a first person using an out-sourced manufacturing process starting with (N) starting product assemblies and producing (M) completed products;
supplying a yield monitoring assembly in communication with said second person and in communication with said first person;
establishing a warning threshold;
calculating a measured out-sourced manufacturing process yield equal to (M)/(N);
determining if said measured out-sourced manufacturing process yield is greater than said warning threshold; and
operative if said measured out-sourced manufacturing process yield is not greater than said warning threshold, providing a warning message to said first person.

2. The method of claim 1, further comprising the steps of:
selling all or a portion of said (M) completed products to a customer of said first person; and
operative if said measured out-sourced manufacturing process yield is not greater than said warning threshold, providing said warning message to said customer.

3. The method of claim 1, further comprising the steps of:
providing all or a portion of said (M) completed products to an in-company manufacturing process owned by said first person; and
operative if said measured out-sourced manufacturing process yield is not greater than said warning threshold, providing said warning message to said in-company manufacturing process.

4. The method of claim 1, further comprising the steps of:
establishing an alert threshold;
determining if said measured out-sourced manufacturing process yield is greater than said alert threshold; and
operative if said measured out-sourced manufacturing process yield is not greater than said alert threshold, providing an alert message to said first person.

5. The method of claim 4, further comprising the steps of:
selling all or a portion of said (M) completed products to a customer of said first person; and
operative if said measured out-sourced manufacturing process yield is not greater than said alert threshold, providing said alert message to said customer.

6. The method of claim 4, further comprising the steps of:
providing all or a portion of said (M) completed products to an in-company manufacturing process owned by said first person; and
operative if said measured out-sourced manufacturing process yield is not greater than said warning threshold, providing said alert message to said in-company manufacturing process.

7. The method of claim 4, further comprising the steps of:
providing a simple network management protocol comprising a network address;
operative if said measured out-sourced manufacturing process yield is not greater than said warning threshold, setting said network address equal to 3 and providing said network address to said first person;
operative if said measured out-sourced manufacturing process yield is greater than said warning threshold but not greater than said alert threshold, setting said network address equal to 2 and providing said network address to said first person; and
operative if said measured out-sourced manufacturing process yield is greater than both said warning threshold and said alert threshold, setting said network address equal to 1 and providing said network address to said first person.

8. The method of claim 4, further comprising the steps of:
determining whether a revised warning threshold is needed;
operative if a revised warning threshold is needed, generating a revised warning threshold; and
providing said revised warning threshold to said yield monitoring assembly.

9. The method of claim 4, further comprising the steps of:
determining whether a revised alert threshold is needed;
operative if a revised alert threshold is needed, generating a revised alert threshold; and
providing said revised alert threshold to said yield monitoring assembly.

10. An article of manufacture comprising a computer readable medium having computer readable program code disposed therein to monitor an out-sourced manufacturing process which manufactures a product by a second person under contract with a first person using an out-sourced manufacturing process starting with (N) starting product assemblies and producing (M) completed products, wherein said article of manufacture is in communication with said second person and in communication with said first person, the computer readable program code comprising a series of computer readable program steps to effect:
receiving a warning threshold;
calculating a measured out-sourced manufacturing process yield equal to (M)/(N);
determining if said measured out-sourced manufacturing process yield is greater than said warning threshold; and
operative if said measured out-sourced manufacturing process yield is not greater than said warning threshold, providing a warning message to said first person.

11. The article of manufacture of claim 10, further comprising a simple network management protocol comprising a network address, said computer readable program code further comprising a series of computer readable program steps to effect:
operative if said measured out-sourced manufacturing process yield is not greater than said warning threshold, setting said network address equal to 3 and providing said simple network management protocol network address to said first person.

12. The article of manufacture of claim 10, said computer readable program code further comprising a series of computer readable program steps to effect:
establishing an alert threshold;
determining if said measured out-sourced manufacturing process yield is greater than said alert threshold; and
operative if said measured out-sourced manufacturing process yield is not greater than said alert threshold, providing an alert message to said first person.

13. The article of manufacture of claim 12, further comprising a simple network management protocol comprising a network address, said computer readable program code further comprising a series of computer readable program steps to effect:
operative if said measured out-sourced manufacturing process yield is greater than said warning threshold but not greater than said alert threshold, setting said network address equal to 2 and providing said simple network management protocol network address to said first person.

14. The article of manufacture of claim 13, said computer readable program code further comprising a series of computer readable program steps to effect:
operative if said measured out-sourced manufacturing process yield is greater than both said warning threshold and said alert threshold, setting said network address equal to 1 and providing said simple network management protocol network address to said first person.

15. A computer program product encoded in an information storage medium wherein said computer program product is usable with a programmable computer processor to monitor an out-sourced manufacturing process which manufactures a product by a second person under contract with a first person using an out-sourced manufacturing process starting with (N) starting product assemblies and producing (M) completed products, comprising:
computer readable program code which causes said programmable computer processor to retrieve a pre-determined warning threshold;
computer readable program code which causes said programmable computer processor to calculate a measured out-sourced manufacturing process yield equal to (M)/(N);
computer readable program code which causes said programmable computer processor to determine if said measured out-sourced manufacturing process yield is greater than said warning threshold; and
computer readable program code which, if said measured out-sourced manufacturing process yield is not greater than said warning threshold, causes said programmable computer processor to provide a warning message to said first person.

16. The article of manufacture of claim 15, further comprising:
computer readable program code which, if said measured out-sourced manufacturing process yield is not greater than said warning threshold, causes said programmable computer processor to set a simple network management protocol network address equal to 3;
computer readable program code which causes said programmable computer processor to provide said simple network management protocol network address to said first person.

17. The article of manufacture of claim 15, further comprising:
computer readable program code which causes said programmable computer processor to retrieve a pre-determined alert threshold;
computer readable program code which causes said programmable computer processor to determine if said measured out-sourced manufacturing process yield is greater than said alert threshold; and
computer readable program code which, if said measured out-sourced manufacturing process yield is not greater than said alert threshold, causes said programmable computer processor to provide an alert message to said first person.

18. The article of manufacture of claim 17, said computer readable program code further comprising a series of computer readable program steps to effect:
computer readable program code which, if said measured out-sourced manufacturing process yield is greater than said warning threshold but not greater than said alert threshold, causes said programmable computer processor to set a simple network management protocol network address equal to 2; and
computer readable program code which causes said programmable computer processor to provide said simple network management protocol network address to said first person.

19. The article of manufacture of claim 17, further comprising:
computer readable program code which, if said measured out-sourced manufacturing process yield is greater than both said warning threshold and said alert threshold, causes said programmable computer processor to set a simple network management protocol network address equal to 1; and
computer readable program code which causes said programmable computer processor to provide said simple network management protocol network address to said first person.
